(19) United States
(12) Patent Application Publication
(10) Pub. No.: US 2017/0341241 A1
(43) Pub. Date: Nov. 30, 2017

(54) TRANSFER ASSEMBLY

(71) Applicant: COMMISSARIAT À L'ENERGIE ATOMIQUE ET AUX ENERGIES ALTERNATIVES, Paris (FR)

(72) Inventors: François GRANET, Merignac (FR); Frédéric LEURET, Begles (FR); Iban TISSIER, Salles (FR)

(73) Assignee: COMMISSARIAT À L'ENERGIE ATOMIQUE ET AUX ENERGIES ALTERNATIVES, Paris (FR)

(21) Appl. No.: 15/535,216

(22) PCT Filed: Dec. 7, 2015
(86) PCT No.: PCT/FR2015/053340

§ 371 Date: Jun. 12, 2017

(30) Foreign Application Priority Data
Dec. 12, 2014 (FR) 14/62383

(51) Int. Cl. B25J 21/02; G21F 7/005; G21F 5/12; G21F 7/047; B01L 1/02; F16J 13/08; F16J 12/00

(52) U.S. Cl. CPC B25J 21/02; G21F 7/047; G21F 7/005; B01L 1/02; G21F 5/12; F16J 12/00; F16J 13/08

(57) ABSTRACT

An assembly for transferring an element from or towards the inside of a closed contaminated enclosure having an opening. The transfer assembly includes a first door closing substantially sealingly the opening of the contaminated enclosure and a transfer box delimiting an enclosed space and having an opening closed by a second door configured to pivot towards the inside of the transfer box, the first door and the second door each having at least one coupling member configured to allow the coupling of the first door and of the second door and configured to allow the first door and the second door, coupled to one another, to pivot towards the inside of the transfer box.

The present invention concerns an assembly for transferring an element from, or towards, a contaminated enclosure.

In the medical, chemical and nuclear fields, the manipulation of contaminating elements is carried out in a hermetic enclosure.

This enclosure is then called contaminated and should remain sealed off from the external environment.

The extraction of an element located inside the enclosure, should meet strict safety standards in order to protect the external environment and the operators, from any contamination.

Thus, it is necessary to guarantee the sealing of the contaminated enclosure before, during and after the transfer.

In order to extract an element from a contaminated enclosure, it is known to use transfer boxes.

Most often, the transfer boxes are sealingly docked at an opening of the contaminated enclosure.

The element to be extracted is manipulated from the inside of the contaminated enclosure.

The known transfer boxes serve only as a receptacle and have a door opening towards the inside of the contaminated enclosure.

However, these transfer boxes do not allow ensuring the sealing of the contaminated enclosure and of the connection, when the contaminated enclosure is under vacuum (at most 10⁵ Pascals),

The current mode of opening of the door of the transfer box does allow ensuring the sealing of a contaminated enclosure under vacuum.

Indeed, when the contaminated enclosure is under vacuum, a connection door opening towards the inside of the contaminated enclosure, hardly withstand the depression created inside the contaminated enclosure and may generate a leakage rate.

Furthermore, in the case, for example, of a very large volume contaminated enclosure, it may not be possible to manipulate the contaminated object from the inside of the contaminated enclosure.

Another known solution consists in connecting a manipulation airlock between the contaminated enclosure and the transfer box.

However, the addition of a vacuum valve between the contaminated enclosure and the transfer box complicates the transfer and limits the accessibility to the inside of the contaminated enclosure.

In this technical context, an aim of the present invention is to guarantee the sealing of a contaminated enclosure under vacuum and to guarantee the sealing during a transfer of an element between the contaminated enclosure and a transfer box.

It is specified in the present application that the term door is defined by the assembly formed by an opening in a surface which delimits an enclosed space and a movable panel allowing closing the opening.

According to a general definition, the invention concerns an assembly for transferring an element from or towards the inside of a closed contaminated enclosure having an opening. The transfer assembly according to the invention comprises (i) a first door closing substantially sealingly the opening of the contaminated enclosure and (ii) a transfer box delimiting an enclosed space and having an opening closed by a second door configured to pivot towards the inside of the transfer box. The first door and the second door each having at least one coupling member configured to allow the coupling of the first door and of the second door and configured to allow the first door and the second door, coupled to one another, to pivot towards the inside of the transfer box.

The use of two distinct doors designed to be coupled and to pivot towards the inside of the transfer box when they are coupled, allows the transfer assembly, according to the invention, to guarantee the sealing of a contaminated enclosure under vacuum and to guarantee the sealing of the transfer.

Indeed, the mode of opening of the first door towards the inside of the transfer box, and thus towards the outside of the contaminated enclosure, allows it to withstand a high depression inside the enclosure without generating a leakage rate.

In addition, the mode of opening of the coupled doors allows actuating the doors from the transfer box and manipulating the element, to be extracted from the contaminated enclosure, from the transfer box.

The first door may comprise a frame, a door leaf, members for fastening the door leaf on the frame and at least one stop adapted to block a translation of the door leaf towards the inside of the contaminated enclosure.

Thus, during a depression inside the contaminated enclosure, the door leaf of the first door exerts a force on the stop and thus guarantees the sealing of the contaminated enclosure by preventing the exhaust of a leakage rate.

The transfer box may have at least one orifice configured to allow the insertion of a hand of a user into the transfer box.

The coupling member of the first door may comprise at least one cavity configured to receive a correspondingly shaped core of the second door.

The second door may have a maneuvering member.

The second door has an unlocking member configured to allow the unlocking and the locking of the second door.

According to an embodiment, at least one pivoting handle, positioned inside the transfer box, may comprise the maneuvering member and the unlocking member.

At least one glove may be assembled to said at least one orifice, in order to protect a hand of a user during its insertion into the transfer box.

The transfer assembly may comprise at least one sensor configured to detect the opening and the closing of the second door.

In addition, the transfer assembly may comprise a control device connected to said at least one sensor.

Other features and advantages of the invention will emerge from the description which follows, relative to the appended drawings which will represent an embodiment of the invention.

FIG. 1 is a perspective view of the transfer assembly according to the invention when the first door and the second door are not coupled;

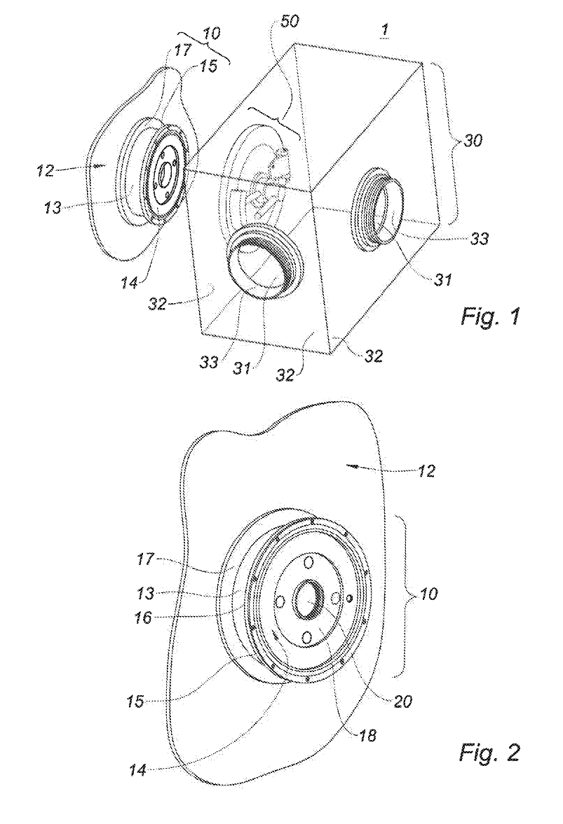

FIG. 2 is a perspective view of the first door fastened to the contaminated enclosure;

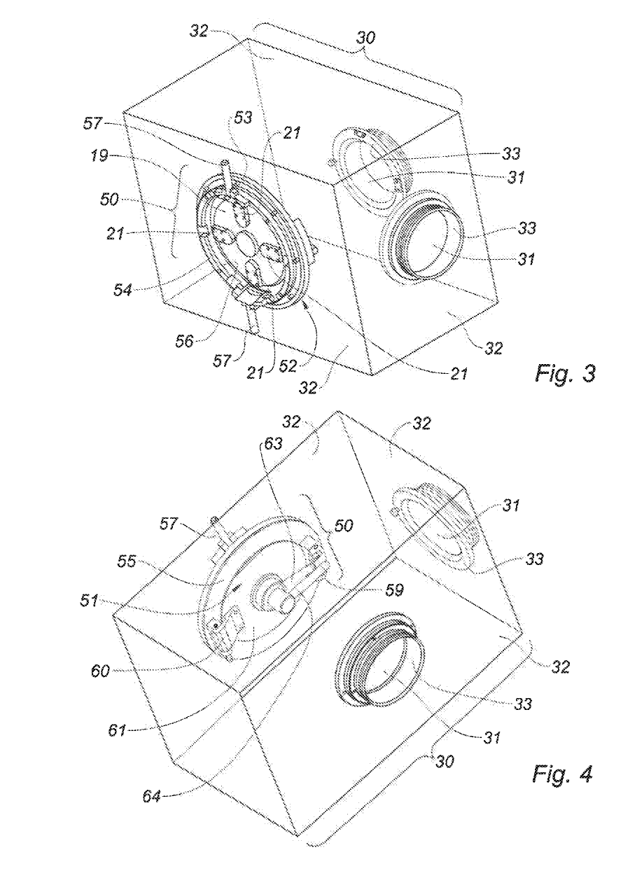

FIG. 3 is a perspective view, from behind, of the transfer assembly when the first door and the second door are coupled;

FIG. 4 is a front perspective view of the transfer box;

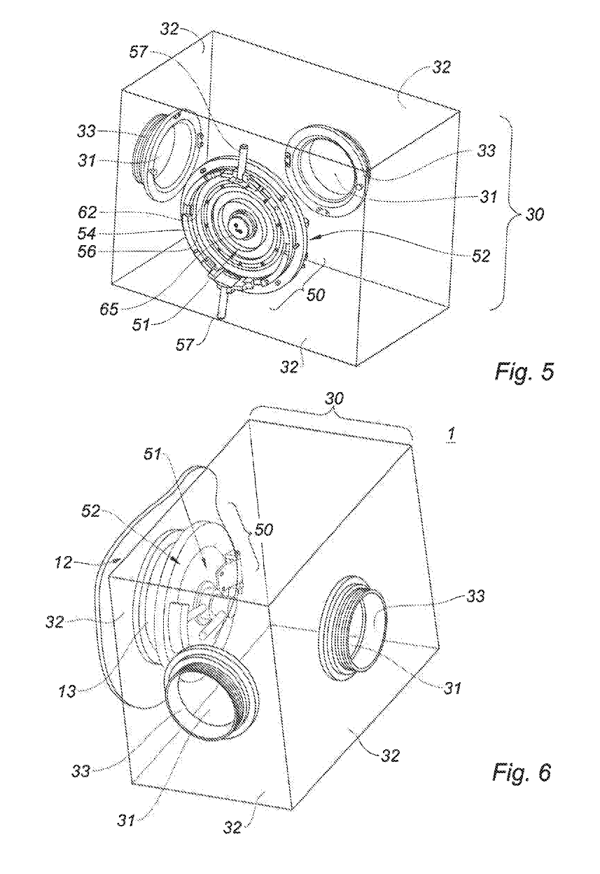

FIG. 5 is a perspective view, from behind, of the transfer box;

FIG. 6 is a front perspective view of the transfer assembly when the first door and the second door are coupled and in the closed position;

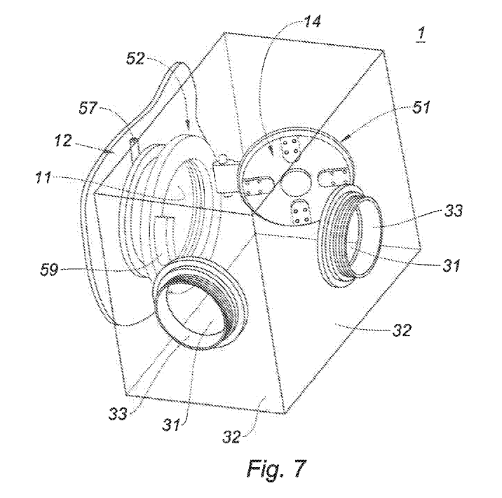

FIG. 7 is a front perspective view of the transfer assembly when the first door and the second door are coupled and in the open position;

Referring to FIG. 1, the transfer assembly 1 essentially comprises a first door 10, a transfer box 30 and a second door 50.

The first door 10 is represented in FIG. 2.

The first door 10 is designed to close substantially sealingly an opening 11 of a contaminated enclosure 12.

The first door 10 comprises a frame 13 and a door leaf 14.

The frame 13, of the first door 10, is fastened on the contaminated enclosure 12 and delimits the opening 11.

According to the embodiment presented here, the frame 13 of the first door 10, has a substantially tubular shape having two ends.

An end, called inner end 17, of the frame 13 of the first door 10 opens inside the contaminated enclosure 12.

An end, called outer end 15, of the frame 13 of the first door 10 opens outside the contaminated enclosure 12.

The outer end 15 has a circular return 16.

Furthermore, according to an embodiment, four slots, not represented, are formed inside a portion of the outer end 15.

The four slots are diametrically opposite two by two.

According to the embodiment presented here, the door leaf 14 of the first door 10 has a substantially circular shape. The door leaf 14 of the first door 10 has a coupling face 18 and a locking face 19 (represented in FIG. 3).

The coupling face 18 has a cavity 20. The cavity 20 is substantially positioned at the center of the coupling face 18.

The cavity 20 comprises a member (not represented) for controlling the locking and the unlocking of the door leaf 14 of the first door 10.

As shown in FIG. 3, the locking face 19 comprises four brackets 21. The four brackets 21 are diametrically opposite two by two and are positioned at the periphery of the locking face 19. Each bracket 21 comprises a bolt (not represented).

The transfer box 30 is represented in FIGS. 1, 3, 4, 5 and 6.

According to the embodiment presented here, the transfer box 30 has a parallelepiped geometry.

The transfer box 30 may, for example, be made of a transparent polymer material.

The transfer box 30 has two orifices 31. The orifices 31 are sized to each allow the passage of a hand and a forearm of a user.

According to the embodiment presented here, the orifices 31 are each formed in a wall 32 of the transfer box 30. The two walls 32 being adjacent.

However, according to another embodiment, the two orifices 31 may be formed in the same wall 32 of the transfer box 30.

Each orifice 31 is provided with a glove port 33 enabling the sealed fastening of a glove.

Another wall 32 of the transfer box 30 comprises the second door 50.

According to the embodiment presented here, the second door 50 is positioned facing an orifice 31.

The second door 50 comprises a door leaf 51 and a frame 52.

The frame 52 comprises a chassis 53 and a coupling ring 54.

According to the embodiment presented here, the chassis 53 has a cylindrical shape.

A first end of the chassis comprises a collar 55 and a second end of the chassis is provided with the coupling ring 54.

The coupling ring 54 is positioned outside the transfer box 30.

The coupling ring 54 has an inner groove 56. In addition, the coupling ring 54 is pivotally mounted in the chassis 53.

Furthermore, as may be noted in FIGS. 3 and 5, the coupling ring 54 comprises two diametrically opposite handles 57.

As will be subsequently developed, the coupling ring 54, is designed to be docked on the circular return 16.

The collar 55 is positioned inside the transfer box 30.

It is shown in FIG. 4 that the collar 55 comprises a striker 59 and a hinge 60.

The hinge 60 is connected to the door leaf 51 of the second door 50.

The leaf 51 has an inner face 61 and an outer face 62.

According to the embodiment presented here, the door leaf 51 has the shape of a disc.

The inner face 61 comprises a rotary bolt 63 and a maneuvering pivoting handle 64.

Referring to FIG. 5, the outer face 62 has a core 65 substantially positioned at the center of the outer face 62 of the door leaf 51.

The core 65 comprises several extensible radial fingers (not represented).

The radial fingers of the core 65 are designed to be maneuvered between a deployed position in which the radial fingers emerge from the core 65 and a retracted position in which the radial fingers are positioned inside the core 65.

The operation of the transfer assembly 1 is the following.

It is specified that the description which follows starts from a situation in which, the first door 10 is in the closed position so as to close the opening 11 of the contaminated enclosure 12. That is to say the door leaf 14 of the first door 10 conceals the outer end 15 of the frame 13 of the first door 10.

The locking face 19 is positioned towards the inside of the contaminated enclosure 12. The bolts of the door leaf 14 are each engaged in a slot of the outer end 15 so as to lock the door leaf 14 to the frame 13.

In this configuration, the first door 10 allows guaranteeing the sealing of the contaminated enclosure 12. In addition, the positioning of the door leaf 14 outside the contaminated enclosure 12 allows the first door 10 to withstand a high depression and thus to guarantee the sealing of the contaminated enclosure 12 when the contaminated enclosure 12 is under vacuum.

In addition, it is specified that the description which follows starts from a situation in which the second door 50 is closed. That is to say, the door leaf 51 of the second door 50 obstructs the frame 52, and the rotary bolt 63 is engaged in the striker 59 in order to lock the door leaf 51 to the frame 52 of the second door 50.

In order to extract an element from the inside of the contaminated enclosure 12, a user should couple the first door 10 to the second door 50 which belongs to the transfer box 30.

Thus, the user docks the coupling ring 54 around the circular return 16. The circular return 16 is engaged in the inner groove 56 of the coupling ring 54. The coupling ring 54 and the circular return 16 cooperate according to a fastening mode of the bayonet joint type. The handles 57 allow the user to pivot the coupling ring 54, in order to lock the connection between the first door 10 and the second door 50.

During the insertion of the circular return 16 into the inner groove 56, the core 65 penetrates into the cavity 18. The radial fingers of the core 65 are positioned in the deployed position. In the deployed position, the radial fingers of the core 65 exert a force in the cavity 18. Thus, in the deployed position, the radial fingers allow the coupling of the door leaf 14 of the first door 10 to the door leaf 51 of the second door 50. In addition, the radial fingers of the core 65 allow actuating the control member positioned in the cavity 18 and thus allow the unlocking of the door leaf 14 of the first door 10. The user may then insert his hands in gloves fastened to the glove ports 33, in order to maneuver the pivoting handle 64.

The user actuates the pivoting handle 64 in order to disengage the bolt 63 from the striker 59 and to place the two coupled door leafs 14 and 51 in the open position.

The user may recover an element in the contaminated enclosure 12 and place it in the transfer box 30.

At the end of the transfer, the user places the two coupled door leafs 14 and 51 in the closed position. The user then maneuvers the pivoting handle 64 in order to engage the bolt 63 in the striker 59 and thus lock the second door 50. In addition, the locking of the second door 50 causes the locking of the first door 10.

The user may then separate the coupling ring 54 and the circular return 16.

Thus, the invention proposes a transfer assembly which allows to guarantee the sealing of a contaminated enclosure under vacuum and which guarantees the sealing of the transfer of an element between the contaminated enclosure and the transfer box.

Of course, the invention is not limited to the sole embodiment of the transfer assembly described above, it embraces on the contrary all the embodiments.

1-10. (canceled)

11. An assembly for transferring an element from or towards the inside of a closed contaminated enclosure having an opening, comprises a first door closing substantially sealingly the opening of the contaminated enclosure and a transfer box delimiting an enclosed space and having an opening closed by a second door configured to pivot towards the inside of the transfer box, the first door and the second door each having at least one coupling member configured to allow the coupling of the first door and of the second door and configured to allow the first door and the second door, coupled to one another, to pivot towards the inside of the transfer box.

12. The transfer assembly according to claim 11, wherein the first door comprises a frame, a door leaf, members for fastening the door leaf on the frame and at least one stop adapted to block a translation of the door leaf towards the inside of the contaminated enclosure.

13. The transfer assembly according to claim 11, wherein the transfer box has at least one orifice configured to allow the introduction of a hand of a user in the transfer box.

14. The transfer assembly according to claim 11, wherein said at least one coupling member of the first door comprises at least one cavity configured to receive a correspondingly shaped core of the second door.

15. The transfer assembly according to claim 11 wherein the second door has a maneuvering member.

16. The transfer assembly according to claim 11, wherein the second door has an unlocking member configured to allow the unlocking and the locking of the second door.

17. The transfer assembly according to claim 15, wherein at least one pivoting handle, positioned inside the transfer box, comprises the maneuvering member and the unlocking member.

18. The transfer assembly according to claim 13, wherein at least one glove is assembled to said at least one orifice, in order to protect a hand of a user during its insertion into the transfer box.

19. The transfer assembly according to claim 11, wherein the transfer assembly comprises at least one sensor configured to detect the opening and the closing of the second door.

20. The transfer assembly according to claim 19, wherein the transfer assembly comprises a control device connected to said at least one sensor.
